(19) United States
(12) Patent Application Publication
(10) Pub. No.: US 2023/0362473 A1
(43) Pub. Date: Nov. 9, 2023

(54) Systems and Methods for Detecting Blood

(71) Applicant: Hose, LLC, Meridianville, AL (US)

(72) Inventor: Mark D. Hose, Meridianville, AL (US)

(73) Assignee: Ann I. Dennen, Huntsville, AL (US)

(21) Appl. No.: 18/144,804

(22) Filed: May 8, 2023

Related U.S. Application Data
(60) Provisional application No. 63/339,266, filed on May 6, 2022.

(51) Int. Cl. H04N 23/61; H04N 23/63; H04N 23/56

(52) U.S. Cl. CPC H04N 23/61; H04N 23/634; H04N 23/56

(57) ABSTRACT

A system that is electronic in nature; that is used to help hunters and crime-scene investigators detect blood. The system provides a variety of alerts to an operator, and these alerts include visual, audible, and vibration.

### CROSS-REFERENCE TO RELATED APPLICATION

The present application claims priority to U.S. Provisional patent application Ser. No. 63/339,266 entitled “Apparatus for Detecting Blood” and filed on May 6, 2022, in its entirety, is incorporated herein by reference.

### BACKGROUND

Hunters spend considerable time recovering game (animals) that have been shot. When the game runs away their blood-trails can become increasingly faint to non-existent. Blood trailing is particularly difficult for hunters with color-blindness. Many color-blind hunters cannot see the red blood; and instead, must depend on other features when trailing blood; such as the glistening of wet blood droplets (which appear as droplets of water). Hunters trail blood at all times of day and night. During daytime, recovery of the blood-trail is observed in the presence of natural sunlight. During nighttime, recovery of the blood-trail requires illumination from an artificial light source (e.g., flashlight or lantern). Hunters know that the blood-trail can come down to a single drop of blood; which can mean the difference in a lost animal or a found trophy. Additionally, crime-scene investigators use luminol in conjunction with special lighting to detect trace amounts of blood at crime-scenes. While luminol helps expose the blood, it contaminates the blood.

### BRIEF DESCRIPTION OF THE DRAWINGS

The present disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views. The present disclosure contains at least one drawing executed in color. Copies of this patent or patent application publication with color drawing(s) will be provided by the United States Patent and Trademark Office (USPTO) upon request and payment of the necessary fee.

FIG. 1A illustrates a front view of a system, according to at least some embodiments, for detecting the presence of blood.

FIG. 1B illustrates a rear view of a system, according to at least some embodiments, for detecting the presence of blood.

FIG. 2 shows a representative graphical user interface, with resultant imagery, for the system of FIGS. 1A and 1B.

FIG. 3 shows a representative graphical user interface with a representative display of resultant imagery and corresponding control settings for the system in FIGS. 1A and 1B; where the corresponding display uses shades of gray for all colors except for colors determined to be associated with blood.

FIG. 4A shows a graphical user interface with a representative display of resultant imagery and corresponding control settings, with the “threshold” control setting set to 0.4, for the system in FIGS. 1A and 1B.

FIG. 4B shows a graphical user interface with a representative display of resultant imagery and corresponding control settings, with the “threshold” control setting set to 0.8, for the system in FIGS. 1A and 1B.

FIG. 5A shows a graphical user interface with a representative display of resultant imagery and corresponding control settings, with the “background style” control setting set to “Blues” (meaning shades of blue/aka blue-scale), for the system in FIGS. 1A and 1B.

FIG. 5B shows a graphical user interface with a representative display of resultant imagery and corresponding control settings, with the “background style” control setting set to “Grays” (meaning shades of gray/aka grayscale), for the system in FIGS. 1A and 1B.

FIG. 5C shows a graphical user interface with a representative display of resultant imagery and corresponding control settings, with the “background style” control setting set to “Fixed” (meaning a user selectable fixed color/like a medium gray color), for the system in FIGS. 1A and 1B.

FIG. 6A shows a graphical user interface with a representative display of resultant imagery and corresponding control settings, with the “background intensity” control setting set to 0.0, for the system in FIGS. 1A and 1B.

FIG. 6B shows a graphical user interface with a representative display of resultant imagery and corresponding control settings, with the “background intensity” control setting set to 0.5, for the system in FIGS. 1A and 1B.

FIG. 6C shows a graphical user interface with a representative display of resultant imagery and corresponding control settings, with the “background intensity” control setting set to 1.0, for the system in FIGS. 1A and 1B.

FIG. 7 shows a graphical user interface with a representative display of resultant imagery, and a map with geographical waypoint location markers and a current geographical location marker, for the system in FIGS. 1A and 1B.

FIG. 8 shows a graphical user interface with a representative display, showing additional functions that include user guide, training, gear guide, and advertisement, for the system in FIGS. 1A and 1B.

FIG. 9 shows graphs of the spectral transmittance of blood and representative camera response curves from Bayer pattern R, G, B filters, related to the processing of the system in FIGS. 1A and 1B.

FIG. 10 shows a three-dimensional RGB (red, green, blue) color space, related to the processing of the system in FIGS. 1A and 1B.

FIG. 11A shows a three-dimensional RGB (red, green, blue) color space, with a pyramid region that encapsulates the colors that represent detectable blood-red colors, for the processing of the system in FIGS. 1A and 1B.

FIG. 11B shows a three-dimensional RGB (red, green, blue) color space, with a larger pyramid region that encapsulates the colors that represent detectable blood-red colors, for the processing of the system in FIGS. 1A and 1B.

FIG. 12A shows a three-dimensional representation of an elliptical paraboloid, with dimension r, g, and b; and an offset value defined as “Rmin”, used for the processing of the system in FIGS. 1A and 1B.

FIG. 12B shows a portion of a three-dimensional representation of an elliptical paraboloid, with dimension r, g, and b; and an offset value defined as “Rmin”, used for the processing of the system in FIGS. 1A and 1B.

FIG. 13A shows a three-dimensional RGB (red, green, blue) color space, with an elliptical paraboloid shaped volume that encapsulates the colors that represent detectable blood-red colors, for the processing of the system in FIGS. 1A and 1B.

FIG. 13B shows a three-dimensional RGB (red, green, blue) color space, with a larger elliptical paraboloid shaped volume that encapsulates the colors that represent detectable blood-red colors, for the processing of the system FIGS. 1A and 1B.

FIG. 14A shows the front view of a cradle device used in conjunction with the system in FIGS. 1A and 1B to provide additional lighting.

FIG. 14B shows the rear view of a cradle device used in conjunction with the system in FIGS. 1A and 1B to provide additional lighting.

FIG. 15A shows the front view of a larger cradle device used in conjunction with the system in FIGS. 1A and 1B to provide additional lighting.

FIG. 15B shows the rear view of a larger cradle device used in conjunction with the system in FIGS. 1A and 1B to provide additional lighting.

FIG. 16 shows an operator using the system in FIGS. 1A and 1B in a “hand-held” configuration to track blood.

FIG. 17 shows an operator using the system in FIGS. 1A and 1B 1 in a “metal detector” configuration to track blood.

FIG. 18 shows an operator using the system in FIGS. 1A and 1B in a “helmet mounted display” (HMD) configuration to track blood.

FIG. 19 shows exemplary display content when the system of FIGS. 1A and 1B is being used in a “helmet mounted” configuration.

FIG. 20 shows the front view of a cradle device used in conjunction with the system in FIGS. 1A and 1B, to provide additional lighting, optical filtration, and optical magnification.

FIG. 21 represents architecture and functionality of the system in FIGS. 1A and 1B.

### DETAILED DESCRIPTION

A system in accordance with an embodiment of the present disclosure assists hunters or crime-scene investigators in the detection of blood. The system alerts the operator when it detects the presence of blood. In one embodiment, the system includes a camera, camera processing, and a display, which represent the basic components for obtaining real-world imagery, processing the imagery, and displaying the processed imagery. The system further comprises control settings, alerts, and lighting controls, which optimize the operation of the system. The system further performs mapping and training to expand utility of the system.

The system captures imagery from the camera, processes that imagery, and renders the corresponding resultant imagery to a display. The resultant imagery retains the color content for the pixels that pertain to detected blood and provides color conversion to those pixels that do not pertain to detected blood. The color conversion method is user selectable and includes grayscale (shades of gray), green-scale (shades of green), blue-scale (shades of blue), and fixed color. Additional color conversion methods include pseudo-coloring and negative (inverted) coloring. The result is that the detected blood-red pixels show up on the display in color, while the other pixels are converted before being displayed to improve contrast. Blood-red colors are defined as those colors associated with blood, resulting from the processed imagery, and based on the control settings.

In at least some embodiments, the system is used in a hand-held capacity with the described methods carried out via an App (software application) executing on a camera-enabled mobile device, e.g., smart-phone like an iPhone.

In one embodiment, the camera-enabled mobile device is hosted within a cradle device that provides additive and subtractive lighting functions. Additive lighting is effectuated via the inclusion of a flashlight function (e.g., LED lights). Subtractive lighting is effectuated via optical filters (e.g., neutral density filters) located directly in the field of view of the camera.

In one embodiment, the camera-enabled mobile device may be hosted within other external devices to include a helmet-mounted display device or a hand-held extension pole device (e.g., like a metal detector).

In one embodiment, the system may be implemented in a custom (without a camera-enabled mobile device) solution capable of implementing some or all of the methods described herein above. Additional methods may be used by other systems in accordance with an embodiment of the present disclosure. The camera can even be physically separated with the imagery passed into a separate processing unit (e.g., remote wireless camera module sending imagery to a camera-enabled mobile device via Wi-Fi connection).

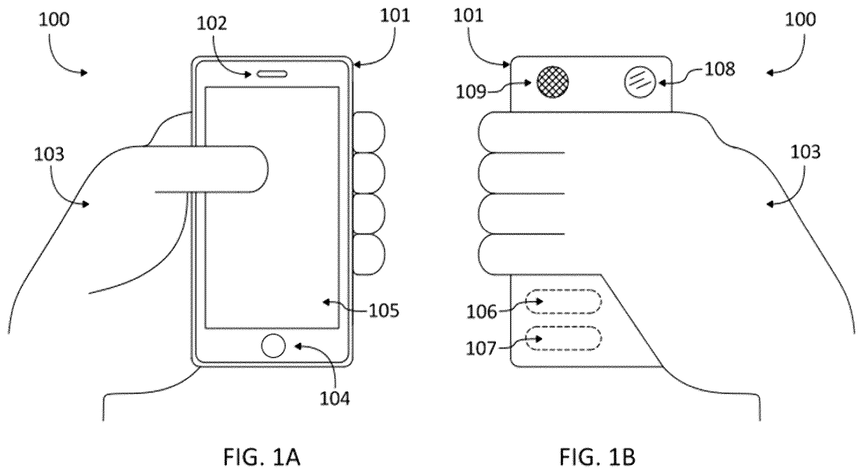

FIG. 1A is system 100 for detecting the presence of blood. System 100 comprises a camera-enabled mobile device 101. FIG. 1A is a front view of a camera-enabled mobile device 101. In one embodiment, the camera-enabled mobile device 101 provides alerts to an operator when it detects the presence of blood in the camera-enabled mobile device's field of view (FOV). A camera-enabled mobile device 101 is held in the operator's hand 103. The camera-enabled mobile device 101 comprises a touchscreen display 105, a speaker 102, and function button 104.

FIG. 1B is a rear view of system 100 for detecting the presence of blood. System 100 comprises a camera-enabled mobile device 101 being held in an operator's hand 103. In this regard, the camera-enabled mobile device 101 further comprises a camera 108, a processor 106, a vibrator 107, and a light 109.

Camera 108 provides input imagery that is passed to processor 106. The processor 106 processes the camera imagery and displays resultant imagery on the touchscreen display screen 105.

In one embodiment, alerts may be output to the operator when blood is detected, and these alerts may include vibrations via the vibrator 107, audible sounds via the speaker 102 (FIG. 1A), and visible cues via the touchscreen display screen 105 (FIG. 1A). Blood is detected when the processor determines that blood-red colors are present. Blood is generally thought of as red in color, but there are several factors that may alter its shades of red or change its appearance to shades of orange. These factors include the level of oxygenation of the blood (lung blood versus liver blood), the amount of time the blood is outside of the host's body, and environmental conditions (e.g., temperature, humidity, precipitation). Blood-red colors are those camera imagery colors that the processor associates with blood.

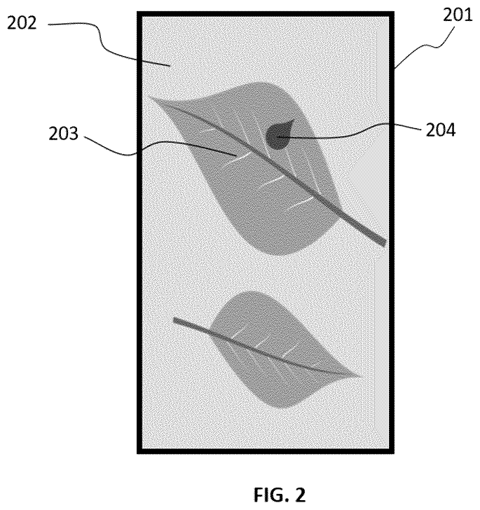

FIG. 2 is an exemplary touchscreen display graphical user interface (GUI) 201, with the resultant imagery 202, for the system 100 (FIGS. 1A and 1B). A green leaf 203 is depicted with a single drop of blood 204 that is located on a surface in the outside environment. In one embodiment, the blood drop is displayed in color, while all other pixels of the resultant image 202 are converted to grayscale values. The grayscale conversion is effectuated by copying a green pixel component for the non-blood pixels into the red and blue components of the pixel. For example, a non-blood-red color RGB (12, 100, 128) is converted to a grayscale value of RGB (100, 100, 100). The processor 106 may also set the shades of gray by averaging the R, G, and B intensities for the pixel, and replacing the R, G, B intensities with the average value. The shades of gray can also be calculated as 0.299×R+0.587×G+0.114×B, where this calculated value is copied into all three RGB components of the pixel.

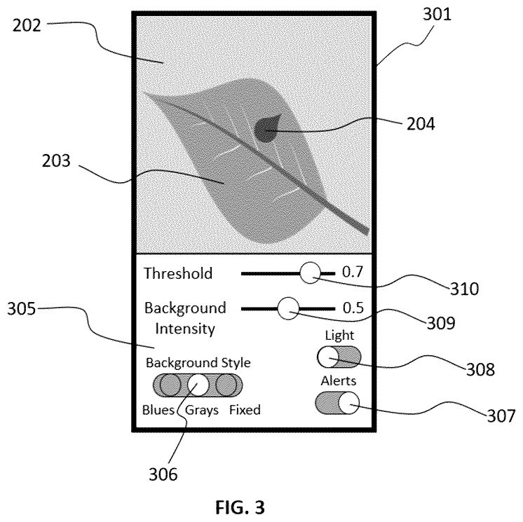

FIG. 3 is an exemplary GUI 301 that may be displayed onto display device 105 (FIG. 1A). This GUI 301 consists of a resultant image portion 202 and a control settings portion 305. The resultant image portion 202 contains a green leaf 203 with a single drop of blood 204 located on the surface of the green leaf 203 as detected in the outside environment. In one embodiment, the control settings portion 305 includes a combination of touch-screen slider and toggle style control elements. The control setting elements include exemplary settings for “threshold” 310 with an exemplary range of 0.1 to 0.8; “background intensity” 309 with an exemplary range of 0.0 to 1.0; “background style” 306 with an exemplary set of selections that include “Blues” (shades of blue for non-blood-red colors), “Grays” (shades of gray for non-blood-red colors), and “Fixed” (a fixed user defined static background color for non-blood-red colors); “Light” 308 (on/off); and “Alerts” 307 (on/off). These control settings 305 are manipulated through the use of the touchscreen display device 105 (FIG. 1A). The control settings 305 may stay on the GUI 301 with the resultant imagery 202, or it may be dynamically brought on and off of the GUI 301 via user interactions with the touch screen.

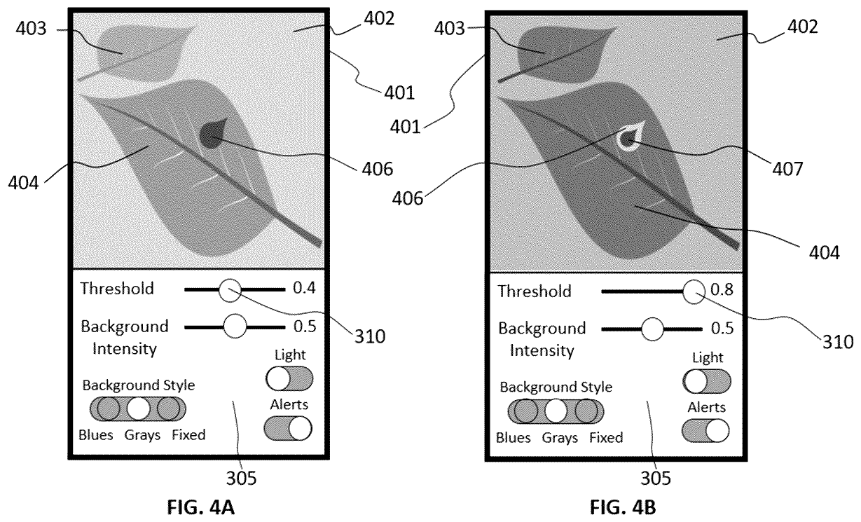

FIGS. 4A and 4B illustrate the effects of the threshold control setting 310. FIG. 4A shows an exemplary GUI 401 comprising a resultant image portion 402 and a control settings portion 305. The resultant imagery 402 includes an orange leaf 403 and a green leaf 404, with the green leaf 404 having a single drop of blood 406 located on its surface as detected in the outside environment. The control panel portion 305 comprises a threshold setting 310. The threshold control setting 310 influences which RGB camera colors are equated to blood and subsequently presented in color, and which RGB camera colors are not equated to blood and subsequently converted (e.g., to grayscale). In one embodiment, the threshold setting 310 is set to a value of 0.4, which is sufficiently low to allow some orange colors like the orange leaf 403 (which are not associated with blood) to be processed by the processor 106 (FIG. 1B) and be presented as detected blood and subsequently displayed in color. So, in this case all the RGB camera colors are converted to grayscale except for those of the orange leaf 403 and the drop of blood 406.

FIG. 4B illustrates the effect of increasing the threshold setting. FIG. 4B includes an exemplary GUI 401, comprising a resultant image portion 402 and a control settings portion 305, applied to the touchscreen display device 105 (FIG. 1A). The threshold control setting 310 has been increased to a value of “0.8” which results in the RGB camera colors associated with the orange leaf 403 to be converted to grayscale along with those of the green leaf 404. The outside portion of the blood drop 406 is converted to grayscale while the center portion of the blood drop 407 is presented in color as detected blood.

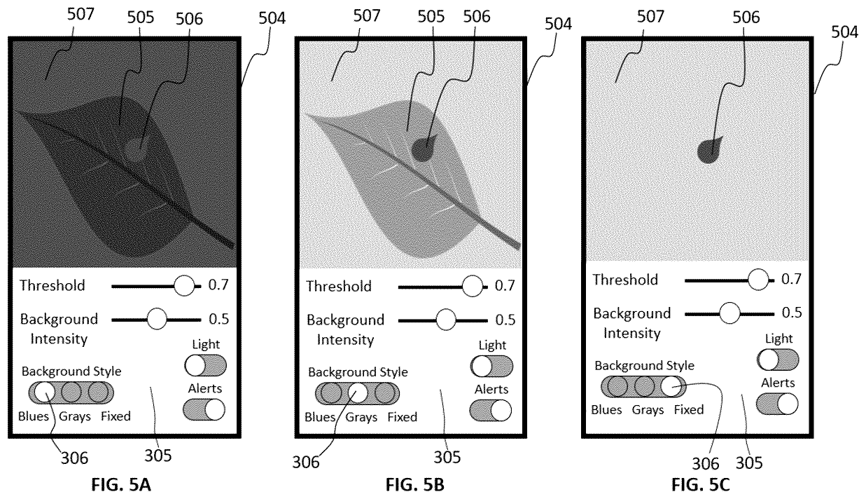

FIGS. 5A, 5B, and 5C illustrate the effects of the “background style” control setting 306. FIG. 5A illustrates the condition where the background style setting 306 is set to “Blues” which produces shades of blue for all RGB camera colors that are determined to not be blood. FIG. 5A shows an exemplary GUI 504 comprising a resultant image portion 507 and a control settings portion 305. The resultant imagery 507 includes a green leaf 505 having a single drop of blood 506 located on its surface as detected in the outside environment. In one embodiment, the shades of blue are created by simply setting the red and green components of the RGB pixel to zero. In another embodiment, processor 106 (FIG. 1B) overwrites the blue component of the RGB pixel with the value of a green component, and subsequently zeros out the red and green components. The processor 106 (FIG. 1B) determines that all RGB camera colors are converted to shades of blue except for those of the blood drop 506, which are presented in color with no conversion to shades of blue.

FIG. 5B shows the effects of setting the “background style” 306 to “Grays”, which results in all RGB camera colors that are determined by the processor 106 (FIG. 1B) to not be associated with detected blood being subsequently converted to shades of gray; while the RGB camera colors determined by the processor 106 (FIG. 1B) to be associated with detected blood are presented in color. FIG. 5B includes an exemplary GUI 504, comprising a resultant image portion 507 and a control settings portion 305, applied to the touchscreen display device 105 (FIG. 1A). The resultant image portion includes a green leaf 505 with a single drop of blood 506 located on the surface of the leaf 505 in an outside environment. Only the blood drop 506 is presented in color; while all other RGB camera colors in the image are converted to shades of gray.

FIG. 5C shows the effects of setting the “background style” 306 to “Fixed” which results in all RGB camera colors that are determined by the processor 106 (FIG. 1B) to not be associated with detected blood being subsequently converted to a user specified fixed color like a low intensity gray value of RGB (25, 25, 25). FIG. 5C includes an exemplary GUI 504, comprising a resultant image portion 507 and a control settings portion 305, applied to the touchscreen display device 105 (FIG. 1A). The resultant image portion includes a green leaf with a single drop of blood 506 located on the surface of the leaf in an outside environment. Only the blood drop 506 is presented in color; while all other RGB camera colors in the image are converted to a fixed color value, including the RGB camera colors for the green leaf.

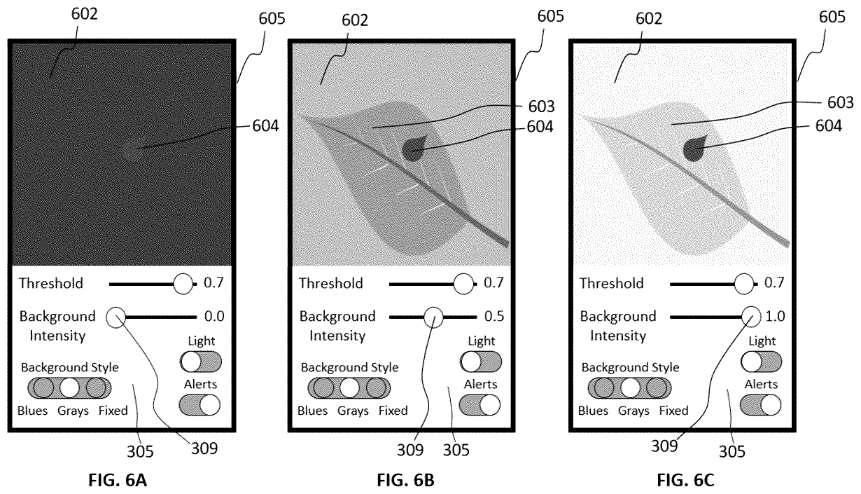

FIGS. 6A, 6B, and 6C illustrate the effects of the “background intensity” control setting 309. FIG. 6A illustrates the condition where the background intensity setting 309 is set to a value of “0.0” which forces all of the RGB camera colors that are determined not to be blood to be converted to the lowest background intensity e.g., RGB (0,0,0). FIG. 6A shows an exemplary GUI 605 comprising a resultant image portion 602 and a control settings portion 305. The resultant imagery 602 includes a green leaf having a single drop of blood 604 located on its surface as detected in the outside environment. The green leaf is not visible in the resultant image 602 because the background intensity setting is “0.0”. It is however converted to grayscale, but not visible due to a 0.0 value for background intensity. The blood drop 604 is however presented in color in the resultant image 602 with no decrease in intensity.

FIG. 6B illustrates the condition where the background intensity setting 309 is set to a value of “0.5” which decreases the intensity of all of the RGB camera colors that are determined not to be blood, to be converted to 50% of their original intensity. FIG. 6B shows an exemplary GUI 605 comprising a resultant image portion 602 and a control settings portion 305. The resultant imagery 602 includes a green leaf 603 having a single drop of blood 604 located on its surface as detected in the outside environment. The intensity of the green leaf 603 is reduced to 50% in the resultant image 602 based on the background intensity setting 309 of “0.5”. The blood drop 604 is presented in color in the resultant image 602 with no decrease in intensity, while the other pixels are converted to grayscale and receive 50% attenuation to their intensities.

FIG. 6C illustrates the condition where the background intensity setting 309 is set to a value of “1.0” which allows the intensity of all of the RGB camera colors that are determined not to be blood, to retain 100% of their original intensity. FIG. 6C shows an exemplary GUI 605 comprising a resultant image portion 602 and a control settings portion 305. The resultant imagery 602 includes a green leaf 603 having a single drop of blood 604 located on its surface as detected in the outside environment. The intensity of the green leaf 603 is maintained at 100% in the resultant image 602 based on the background intensity setting 309 of “1.0”. The blood drop 604 is presented in color in the resultant image 602 with no modification to its intensity, while the other pixels are converted to grayscale and also receive no modification to their intensities.

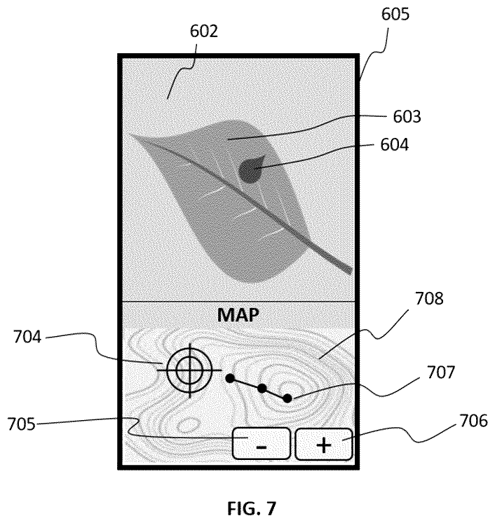

FIG. 7 is the exemplary GUI 605 displaying the resultant imagery 602. The green leaf 603 is depicted with a single drop of blood 604 as detected in the outside environment. The GUI 605 further comprises a map 708 at the bottom portion of GUI 605. Map 708 is a rendering of the map corresponding to the location where device 101 (FIGS. 1A and 1B) is being used. Map 708 comprises one or more waypoints 707 stored for the locations where blood has been detected. It also includes marker 704 of the operator's current location. In one embodiment, the waypoints 707 may be manually added using the control button 706 or removed using a control button 705. The waypoints 704 may be provided by GPS (and perhaps inertial sensors) functions like those that are integral to commercial mobile smart-phone devices, for example.

A virtual reality feature can be produced by exploiting the onboard GPS and inertial measurement sensors within the mobile smart-phone devices. This feature could allow the operator to use the display screen to show the locations of detected blood locations. As the mobile smart-phone device is moved around the location and orientation of the smart-phone could be used to provide the superposition of waypoint markers relating to the locations of the detected blood.

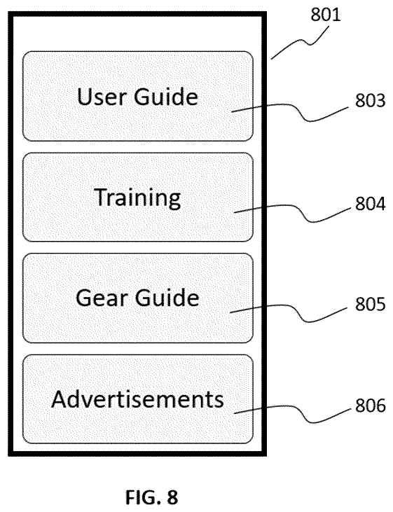

FIG. 8 is an exemplary GUI 801 that comprises selectable content that includes a user guide 803, a training module 804, a gear guide 805, and advertisements 806. The user guide selection 803 provides instruction and trouble shooting material. The training content selection 804 provides training such as proper shot placement to produce heavy blood trails. The gear guide selection 805 provides opportunities to share related gear such as tree stands and weapons. The advertisements selection 806 allows opportunities for promotion and monetization (e.g., in-app purchases). Other options could include image recording functions.

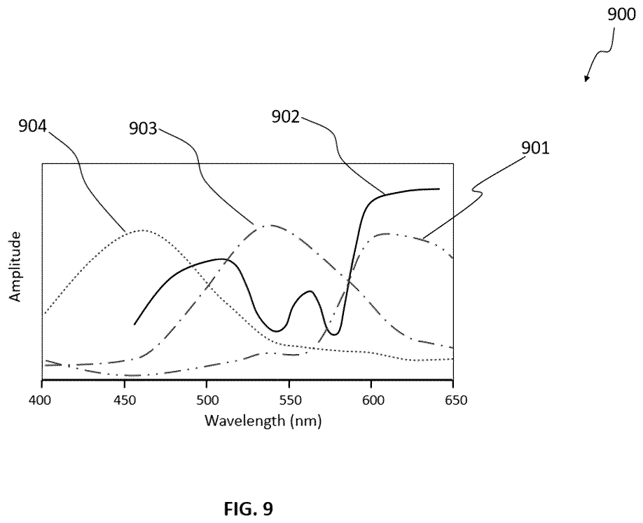

FIG. 9 is a graph 900 overlaying the transmittance spectrum 902 of blood and the spectral responses of the camera 108 (FIG. 1B) RGB pixels, red 901, green 903, and blue 904. The RGB response curves are a result of using Bayer pattern filters, which are typically applied to camera sensors (CMOS, CCD, etc.) to allow them to see color. The Bayer pattern is a technique whereby alternating red, green, and blue filters are applied to the individual pixels of a camera array to produce R, G, B samples. Half of these colored filters are green, and remainder are split between blue and red. This mimics the human photopic vision where M (medium) and L (long) cones combine to produce a bias in the green region. Blood is imaged by camera 108 (FIG. 1B) and converted to color using Bayer or equivalent filters. The spectral distribution of the blood combines with the spectral filtration of the camera filters, and the resultant is processed to determine if blood is present. The transmittance spectrum 902 shows the higher transmittance values are located in the red region of the visible light spectrum (e.g., above 620 nm). The transmittance spectrum 902 also shows appreciable transmittance in blue and green regions with relative amplitudes of approximately 50% of blue with respect to red, and approximately 25% of green with respect to red. Daylight testing yields RGB colors like (201,0,15) and (229, 37, 49). Nighttime testing with artificial light (LED flashlight) yields RGB colors like (223, 48, 64) and (209, 13, 42). For camera RGB pixels resulting from blood, the red component is typically larger than the blue component and the blue component is typically larger than the green component.

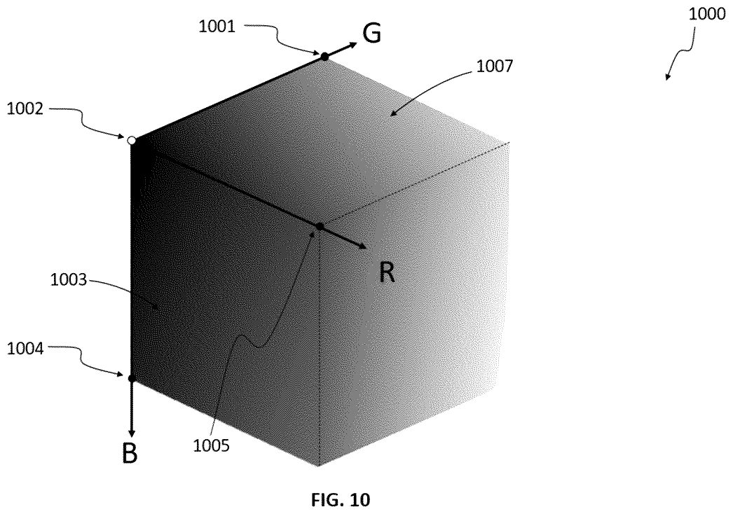

FIG. 10 is an RGB color space cube 1000. The camera 108 (FIG. 1B) and processor 106 (FIG. 1B) map real world colors into the color space represented by the RGB color space cube 1000. In this regard, with each pixel having red (R), green (G), and blue (B) pixel, intensity values ranging from 0 to 255. Abstractly, RGB color space cube 1000 is a three-dimensional cube representation of the R, G, B axes. The RGB color space cube 1000 comprises a vertex 1002 located at RGB (0,0,0) and a G-axis extending out to a location 1001 with RGB coordinates (0, 255, 0). The RGB color space cube 1000 comprises a B-axis that extends out to a location 1004 with RGB coordinates (0, 0, 255) and an R-axis that extends out to a location 1005 with RGB coordinates (255, 0, 0). The RG plane 1007 is a location where B equals to 0. The RB plane 1003 is a location where G equals 0.

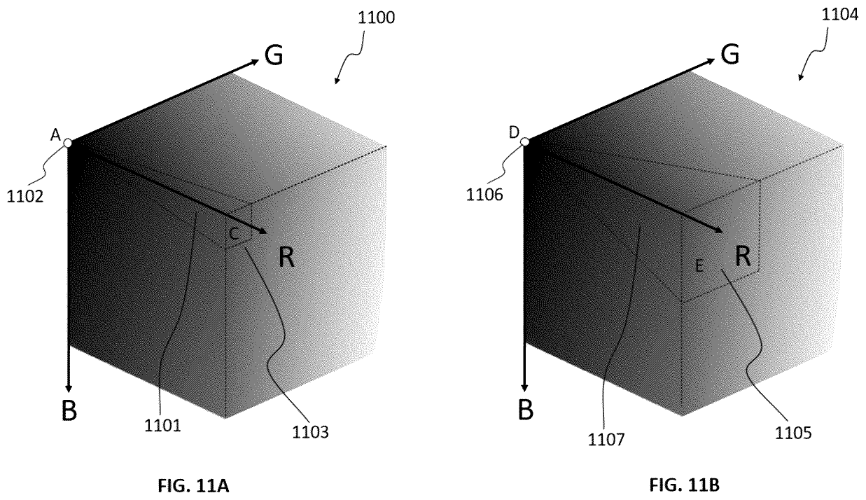

FIG. 11A is an RGB color space cube 1100 with a pyramid shaped volume 1101 defined by the vertex (point A) 1102 and the surface C 1103 shown. RGB pixels falling within this pyramid shaped volume are considered to be blood-red colors. The size of surface B 1103 and the resulting pyramid shaped volume 1101 are determined by the threshold control setting.

FIG. 11B shows the RGB color space cube 1104 with a pyramid-shaped representation 1107 defined by a vertex (point D) 1106 and a surface E 1105. This volume 1107 is larger than the volume 1101; and as such the larger 1107 volume allows a larger number of colors to be considered as blood-red colors; while a smaller volume of the pyramid-shaped representation 1101 allows a smaller number of colors to be considered as blood-red colors. Again, the size of the pyramid-shaped representation 1107 abstractly shows the manner in which processor 106 reacts to manipulation of the threshold control setting 310 (FIGS. 4A and 4B).

Reaction to the manipulation of the threshold setting 310 (FIGS. 4A and 4B) is based on multi-band ratio calculations that are applied to each RGB (red, green, blue) pixel (not shown) from the device 101 (FIGS. 1A and 1B), and the processor 106 (FIG. 1B) applies the selected threshold to these calculated values to determine if a pixel is blood-red. Processor 106 performs calculations mathematically in real-time or prepares them a priori into lookup tables (LUTs) to reduce the computational load on the processor 106. If a calculated value is above the threshold, then it is considered blood-red. If the calculated value is equal to or below threshold it is considered not to be blood-red and subsequently the processor will convert the calculated value per the background style control setting 306 (FIGS. 5A, 5B, and 5C). The processor 106 computes multi-band calculations as follows:

RatioRG=(R−G)/(R+G)

RatioRB=(R−B)/(R+B)

Where R represents the red component of the RGB color pixel, G represents the green component of the RGB color pixel, and B represents the blue component of the RGB color pixel. R, G, and B are integers that range between 0 and 255. The processor 106 applies a divide by zero condition check to handles divisions where both R and G exhibit 0 values, and where R and B exhibit 0 values. The processor 106 builds a RatioRG lookup table (not shown) for all combinations of R and G, with the LUT entry set to one (indicating blood-red) when the ratio is above the “threshold” control setting 310 (e.g., a value of 0.6) or is otherwise set to zero to indicate the color is not blood-red. The processor 106 builds a RatioRB lookup table for all combinations of R and B with the LUT entry set to one (indicating blood-red) when the ratio is above the “threshold” control setting 310 (e.g., 0.6), or is otherwise set to zero to indicate the color is not blood-red. After the RatioRG and RatioRB lookup tables are built, the processor 106 inputs one or more pixels of the camera 108 into the LUTs, and the processor 106 logically ands the RatioRG LUT and RatioRB LUT values together to determine if a blood-red pixel has been detected. Both LUTs have to contain a value of one to indicate a blood-red detection. Field testing has shown that when the threshold computed multi-band values are above 0.6, the processor 106 typically classifies blood correctly. The LUTs are recomputed by processor 106 (FIG. 1B) each time the threshold setting 310 is changed by the user. The blood-red pixels represent the presence of blood and trigger alerts to an operator (not shown) of device 101 (FIGS. 1A and 1B). The processor 106 may alert the operator through visual methods, like simply rendering the blood-red pixels on the display, or by blinking the blood-red pixels on the display or displaying a separate visible alert outside of the resultant image area of the display. In one embodiment, the alerts can include audible alerts such as beeps, tones, or any desired sounds. The alerts can also include vibration where the intensity of the vibration can be fixed or even vary proportionally to the amount of blood present in the image. It should be mentioned that the RatioRG LUT and RatioRB LUT can be combined into a single RGB LUT, or perhaps a single RatioRG LUT can in some cases will suffice. It should also be mentioned that the processing can be performed without the use of LUTs, in which case the computations are performed in real-time.

In one embodiment, processor 106 monitors a camera f-stop and exposure time. There are extreme cases that affect the quality of the resultant RGB values (e.g., very fast exposure times above approximately 1/1800 sec, and very slow exposure times below approximately 1/20 sec). The processor 106 may monitor the exposure time and apply it as a confidence measure used by the system or simply presented to the operator. If the exposure time is considered too short or too long, then the system could notify the operator. These notifications could instruct the operator to introduce additional lighting in the case where the exposure time is very long; and reduce the lighting (e.g., via neutral density filter) in the case where the exposure time is very short.

In one embodiment, artificial intelligence (AI) may be used by processor 106 to optimize the implementation. In this regard, the processor 106 may automatically select the control settings of the control panel 305 based on a myriad of data scenarios (e.g., time of day, time of year, geographic location, weather conditions, atmospheric conditions, camera exposure time, etc.). Perhaps even control the light intensity.

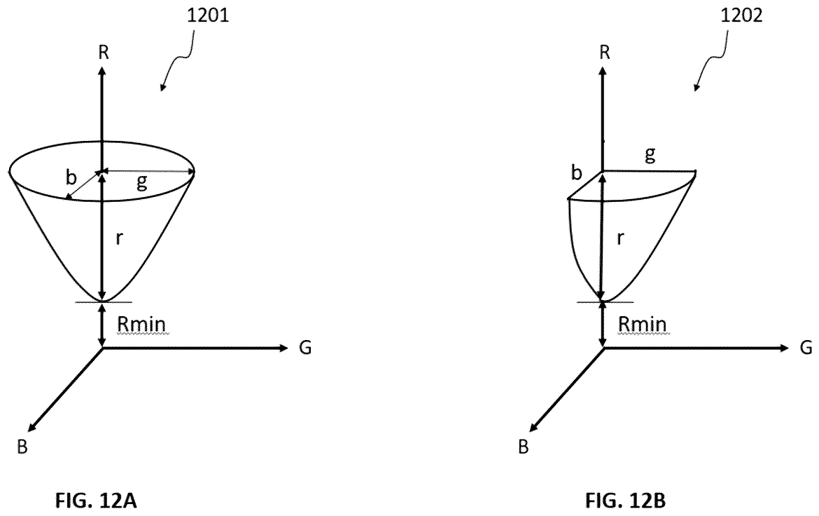

FIG. 12A shows how the detection volume 1201 (previously modeled as a pyramid shaped volume) can be modeled as an elliptical paraboloid with the R, G, and B radii specified by values r, g, and b. An additional offset value “Rmin” is used to further constrain the shape of the volume.

FIG. 12B shows the portion of an elliptical paraboloid 1202 that resides inside of the RGB color space cube. The threshold control setting adjusts the r, g, b radii and the Rmin value, which determine the size of the volume. A single threshold control can be used to vary the r, g, b, and Rmin parameters, or multiple threshold controls can be used to vary the r, g, b, and Rmin parameters.

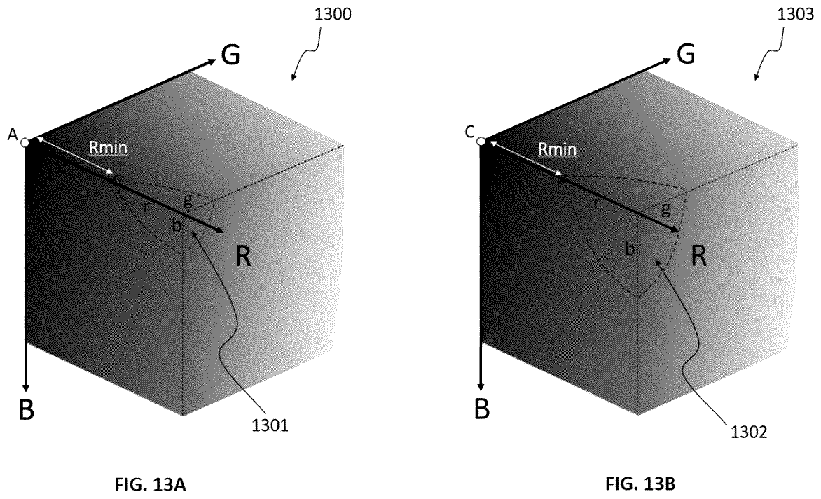

FIG. 13A shows the RGB color space cube 1300 with an elliptical paraboloid shaped detection volume 1301 superimposed with an offset on the R axis specified by Rmin, and the R, G, and B radii defined by values of r, g, and b.

FIG. 13B shows the RGB color space cube 1303 with a larger elliptical paraboloid shaped detection volume 1302 superimposed with an offset on the R axis specified by Rmin, and the R, G, and B radii defined by values of r, g, and b. Again, the threshold control setting controls the size of the detection volume.

The detection volume is intended to contain all colors considered to be blood-red colors; and as such the detection volume can be defined as pyramid, elliptical paraboloid, or combinations of these and other geometric shapes. Portions of the volume can be eliminated; and additional points and volumes can be added to expand the definition of the detection volume.

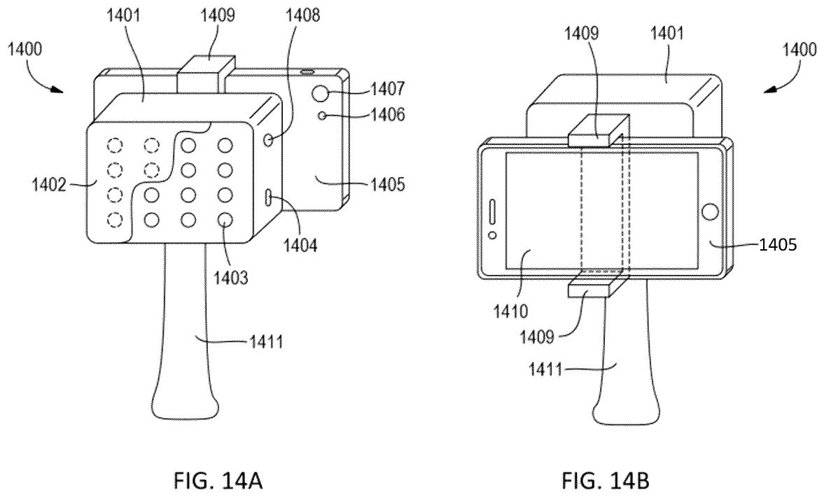

FIG. 14A is a front view of a handheld device 1400 according to one embodiment of the present disclosure. In such an embodiment, the handheld device 1400 delivers alerts to the operator when it detects the presence of blood. A light module 1401 hosts a set of sixteen LEDs 1403 (light emitting diodes) with these LEDs 1403 behind a light diffuser 1402. The light diffuser 1402 is a translucent or semi-transparent cover that spreads out or scatters the light from light module 1401. Using the light diffuser controls brightness and gives off a soft light relative to light 1401. The light 1401 has an On/Off switch 1408 and a charging port 1404 in the case where rechargeable batteries are employed. The light 1401 supplements a smart-phone light with a bright diffused light source. A mobile smart-phone device 1405 (with camera 1407 and integral light 1406) is held in place by an adjustable clamp 1409 that is designed to accommodate all or at least a wide range of commercially available mobile smart-phone devices. A handle 1411 is included and it's length can be short and compact; or long like a selfie-stick. The construction allows the vibratory alerts to be felt through the handle.

FIG. 14B is a rear view of device 1400 according to an embodiment of the present disclosure. In such an embodiment, the handheld device 1400 delivers alerts to the operator when it detects the presence of blood. The light module 1401 faces away from the operator. The mobile smart-phone device 1405 is held in place with the adjustable clamp 1409 so that a display device 1410 is visible to the operator while holding the device 1400. Again, the construction allows the vibratory alerts to be felt through handle 1411.

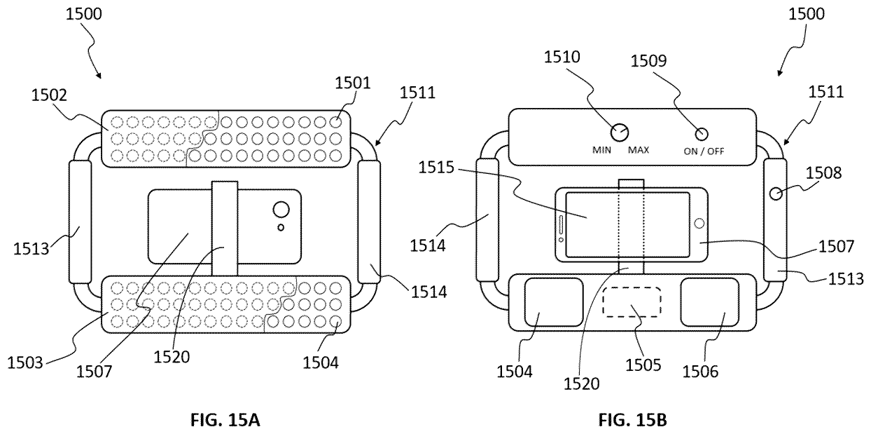

FIG. 15A is a front view of a system 1500 according to an embodiment of the present disclosure. The system 1500 comprises a frame 1511 and a mobile smartphone device 1507. In use, the operator grasps handles 1513 and 1514. System 1500 delivers alerts to an operator when it detects the presence of blood. The mobile smart-phone device 1507 is held in place with an adjustable clamp 1520. A pair of diffused light modules 1502 and 1503 provide a total of 90 LEDs (1501 and 1504). The frame 1511 with side handles 1513 and 1514 hosts the components and forms the system 1500.

FIG. 15b is a rear view of system 1500 according to an embodiment of the present disclosure. System 1500 delivers alerts to an operator when it detects the presence of blood. The mobile smart-phone device 1507 is held in place with an adjustable clamp 1520. A pair of removeable and rechargeable batteries 1504 and 1506 provide power to the diffused light modules and Bluetooth electronics module 1505. A display screen 1515 is visible to the operator as the mobile smart-phone device 1507 is held in place by an adjustable clamp 1520. Light intensity is controlled by an On/Off button 1509 and a dimmer dial 1510. A Bluetooth button 1508 is included to provide an alternate means to initiate features such as mapping functions. The frame 1511 with side handles 1513 and 1514 integrates the components to form a complete system.

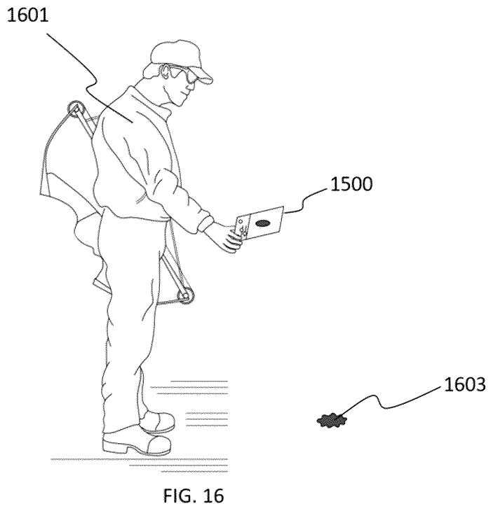

FIG. 16 shows an operator (e.g., and hunter) 1601 operating system 1500 in a hand-held capacity. The operator 1601 looks at the display of system 1500 while moving it over the ground searching for blood 1603. The visual, audible, and vibratory alerts notify the operator when blood has been detected.

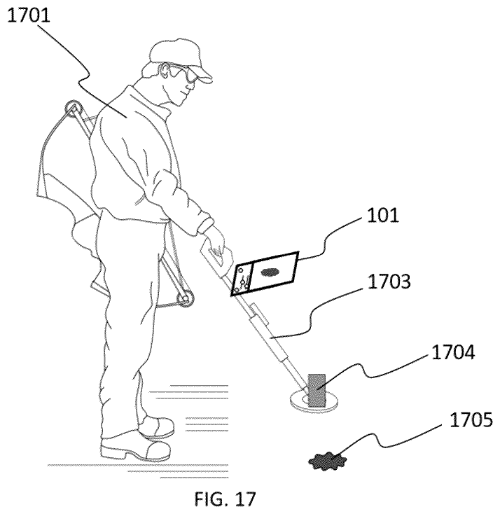

FIG. 17 shows an operator (e.g., a hunter) 1701 using a mobile device 101 (FIGS. 1A and 1B) with an extension-pole 1703 fashioned after a metal detector frame. The operator moves the device, which is comprised of a metal detector frame 1703, a device 101, and a Wi-Fi camera module 1704 mounted at the end of the frame 1703. The Wi-Fi camera module 1704 transmits imagery to device 101. Device 101 performs all of the aforementioned processing based on the control settings. The operator 1701 moves the camera module 1704 over the ground looking for blood 1705. The visual, audible, and vibration alerts notify the operator when blood has been detected. The audio could mimic the sounds of a traditional metal detector (crackling squelch with tones) in this (or any) configuration.

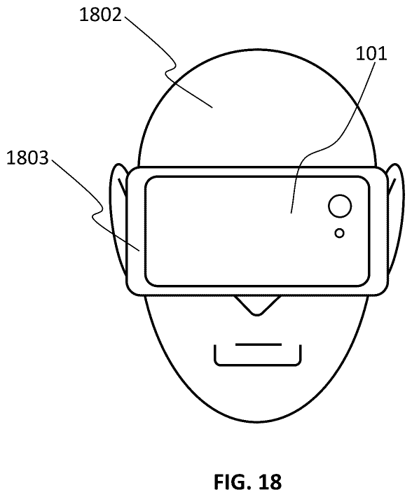

FIG. 18 is an operator 1802 wearing a helmet-mounted device 1803 that physically hosts the device 101 (FIGS. 1A and 1B). Device 101 is mounted in a helmet-mounted carrier 1803 with the display facing the operator's eyes. The operator moves the device 101 around by moving his/her head looking for blood. The visual, audible, and vibratory alerts notify the operator when blood has been detected.

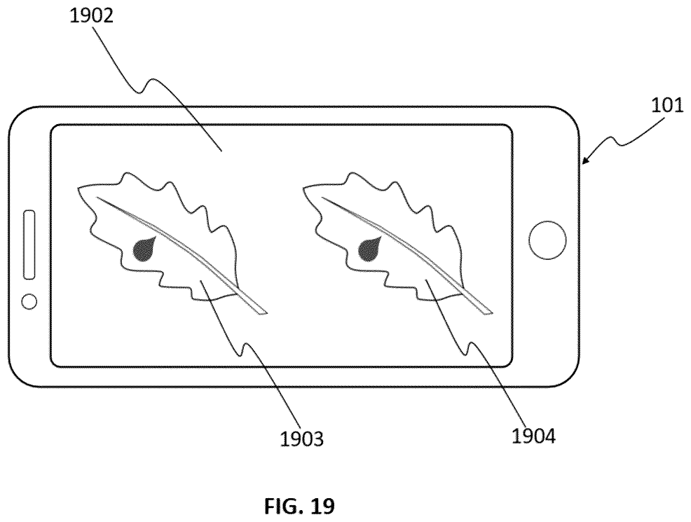

FIG. 19 is a display 1902 in accordance with an embodiment of the present disclosure and which supports the device 101 (FIGS. 1A and 1B) mounted to a helmet. In such an embodiment, the processor 106 (FIG. 1B) displays imagery 1902 duplicated in two places on the screen (1903, 1904) where the operator's left eye (not shown) is presented the left image 1903 and the operator's right eye (not shown) is presented the right image 1904. The graphics for the controls are hidden during operation.

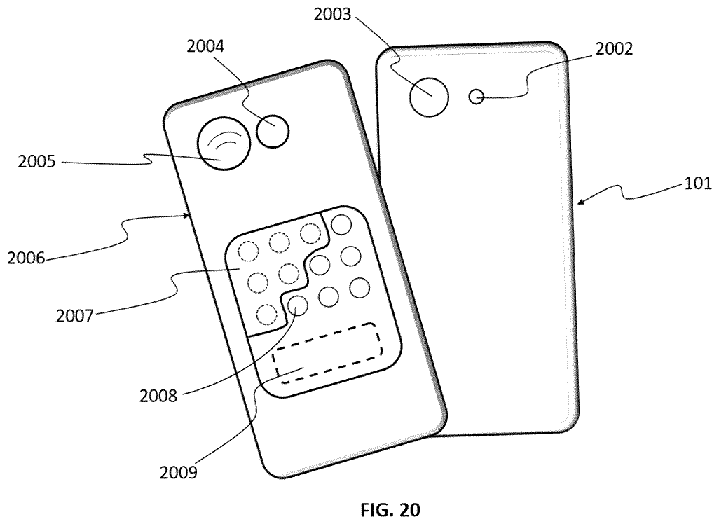

FIG. 20 is a device 101 combined with a device caddy 2006. The caddy 2006 comprises additional lighting via a diffused light 2007 comprising a plurality of LEDs 108. Further, the caddy comprises optical magnification and/or filtration to a camera 2003 via a lens 2005. The light 2007 is powered by a battery 2009. A cut-out 2004 allows the existing light 2002 on the device 101 to shine through.

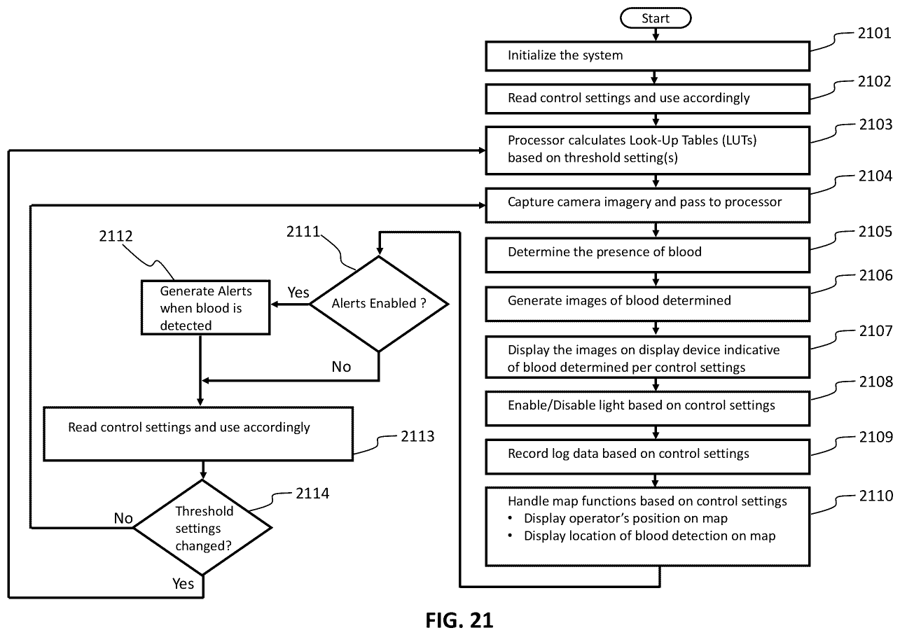

FIG. 21 represents the architecture and functionality of the system. In step 2101, the system performs initialization. Initialization consists of powering up the system and launching the system software. In step 2102, the control settings are read in by the software and these settings are retained for use until otherwise changed. Changes in the control settings are picked up by the software using customary interrupt and polling methods. In step 2103, the processor performs the necessary calculations to build the lookup tables (LUTs). These computations are performed each and every time the threshold setting(s) changes. A red, green LUT is built, and its entries are either zero (indicating that the red and green combination does not constitute an RGB camera color consistent with blood) or one (indicating that the red and green combination does constitute an RGB camera color consistent with blood). A red, blue LUT is built in similar fashion with entries consisting of either zero (indicating that the red and blue combination does not constitute an RGB camera color consistent with blood) or one (indicating that the red and blue combination does constitute an RGB camera color consistent with blood). In step 2104, the camera imagery is captured and its RGB pixel data is available to the processor. In step 2105, the processor determines if there is blood present in the RGB camera imagery. This determination consists of logically ANDing the two LUT values for the corresponding RGB pixel components. In step 2106, resultant images are generated based on the control settings and the corresponding processing thereof. The pixels that the processor determines to be blood retain their color; while the pixels that the processor determines to not be blood are converted based on the control settings (e.g., background style, background intensity). These conversions involve changing the non-blood pixels to shades of gray, or shades of blue, or to a user defined fixed color. In step 2107, the resultant images are displayed to the user. In step 2108, a light function (e.g., LEDs) is used to increase the available light. A light control setting is used to enable and disable this function. In step 2109, a log function is used to record specific data to include geographical waypoint locations and resultant images that contain blood. In step 2110, a series of map functions are supported. These map functions include a feature to display maps on a portion (or over the entirety) of the display, and to overlay waypoints onto the map that relate to geographic locations of the blood and/or the operator. In step 2111, the control setting that enables and disables the alerts is evaluated. In step 2112, the alerts are enabled and are therefore evoked when blood is detected, and these alerts are presented to the operator in a variety of forms to include visual, audible, and vibratory. If alerts are disabled, then the processor disables the presentation of the alerts. In step 2013, the control settings are evaluated to see if there have been any changes. These changes are determined via standard software interrupts and polling. In step 2114, the control setting(s) for threshold(s) is evaluated to determine if there has been a change in the setting. Each time a threshold setting changes, the LUTs have to be recomputed. If the threshold settings have not changed, then the LUT is not required to be recomputed. It should be mentioned that LUTs are included for the purpose of reducing computational load on the processor; however, these computations could otherwise be performed in real-time without the use of LUTs.

What I claim is:

1. A system, comprising:
a display device comprising a camera and a touchscreen;
a processor configured for determining the presence of blood based on images captured by the camera and generating images on the display device indicative of the blood determined or generating alerts to an operator of the presence of blood.

2. The system of claim 1, wherein the processor is further configured for generating alerts when the blood is detected.

3. The system of claim 1, further comprising displayed control settings wherein the processor is further configured for altering the images on the display device based upon operator input via the control settings.

4. The system of claim 1, further comprising a light for illuminating an environment when light is low.

5. The system of claim 1, wherein the processor is further configured for generating log files related to the detection of the blood.

6. The system of claim 1, wherein the processor is further configured for locating a position of the detected blood.

7. The system of claim 1, wherein the processor is further configured for displaying the position of the detected blood on a map showing the position of the detected blood.

8. The system of claim 1, further comprising a control panel displayed to the display panel with the generated images.

9. The system of claim 8, wherein the control panel comprises a threshold control, and when selected, the processor converts non-blood colors of the images to grayscale and displays the images converted to the display device.

10. The system of claim 8, wherein the control panel comprises a background intensity control, and when selected, the processor manipulates the intensity of the non-blood colors and displays the images to the display device.

11. The system of claim 8, where the control panel comprises a background style control, and when selected, the process converts the image to shades of blue for the red/green/blue camera colors that are determined not to be blood.

12. The system of claim 8, wherein the control panel comprises a light control, that when selected turns a light off and on.

13. The system of claim 1, wherein a control panel comprises an alert control, that when selected turns alerts on and off and the alerts comprise visual, audible, or vibratory alerts.

14. The system of claim 1, wherein the display device is a camera-enabled smartphone.

15. The system of claim 1, wherein the processor is configured to display selectable buttons for selectable for content that includes a user guide, a training module, a gear guide, and advertisements.

16. The system of claim 1, wherein the display device is coupled to a carrying device that comprises a handle so that an operator can easily travel with the display device.

17. The system of claim 16, wherein the carrying device comprises a light diffuser spreading and softening light emitted by a light on the display device.

18. The system of claim 16, wherein the carrying device further comprises a clamp for coupling the mobile device to the carrying device.

19. The system of claim 1, wherein the display device is coupled to a frame having one or more handles for grasping the frame so that an operator may grab the handles and travel while viewing the display device.

20. The system of claim 19, wherein the rectangular frame comprises one or more light diffusers coupled thereto for spreading and softening light emitted from the display device.

21. The system of claim 1, wherein the display device couples to an extender and a camera is positioned at an end of the extender.

22. The system of claim 1, wherein the display device is coupled to head gear so that the operator can view images while traveling.

23. The system of claim 1, wherein the display device is coupled to a caddy for coupling to the display device.

24. The system of claim 23, wherein the caddy comprises a light diffuser, a lens, and a cut-out.

25. A method, comprising
determining the presence of blood based on images captured by a camera;
generating images indicative of blood determined;
displaying the images to a display device indicative of the blood determined.

26. The method of claim 25, further comprising generating alerts when the blood is detected.

27. The method of claim 25, further comprising displaying control settings.

28. The method of claim 27, further comprising altering the images on the display device based upon operator input via the control settings.

29. The method of claim 25, further comprising illuminating an outside environment when light is low via a light.

30. The method of claim 25, further comprising generating log files related to detection of the blood.

31. The method of claim 25, further comprising determining a position of the detected blood.

32. The method of claim 31, further comprising displaying the position of the detected blood on a map showing where the operator is located.

33. The method of claim 25, further comprising displaying a control panel contiguous with the displayed images.

34. The method of claim 33, further comprising displaying a threshold control to the control panel, and when selected, converting non-blood colors of the images to grayscale and displaying the images converted to the display device.

35. The method of claim 25, further comprising a background intensity control, and when selected, converting the images to a lowest background intensity and displaying the images converted to the display device.

36. The method of claim 8, further comprising a background style control, and when selected, converting the images to shades of blue for the red/green/blue camera colors that are determined not to be blood.

37. The method of claim 25, further comprising turning a light on and off based on actuation of a light control on a control panel.

38. The method of claim 25, further comprising delivering an alert based on an alerts control on a control panel, that when selected turns alerts on and off.

39. The method of claim 25, further comprising delivering light based upon a light control on a control panel, that when selected turns light on and off.

40. The method of claim 25, wherein the display device is a camera-enabled smartphone.

41. The method of claim 25, further comprising displaying selectable buttons for selectable for content that includes a user guide, a training module, a gear guide, and advertisements.

42. The method of claim 8, further comprising coupling the display device to a carrying device that comprises a handle so that an operator can easily travel with the display device.

43. The system of claim 25, wherein the carrying device comprises a light diffuser, further comprising spreading and softening light emitted by a light on the display device.

44. The system of claim 43, wherein the carrying device further comprises a clamp, further comprising coupling the mobile device to the carrying device via the clamp.

45. The method of claim 25, wherein the display device is coupled to a rectangular frame having one or more handles, further comprising grasping the frame so that an operator may grab the handles and travel while viewing the display device.

46. The method of claim 45, wherein the frame further comprising spreading and softening light via one or more light diffusers coupled thereto.

47. The method of claim 25, further comprising coupling the display device to an extender and a camera is positioned at an end of the extender.

48. The method of claim 25, further comprising coupling the display device to head gear so that an operator can view images while traveling.

48. The method of claim 25, further comprising coupling the display device to a caddy.
